(19) United States
(12) Patent Application Publication
(10) Pub. No.: US 2007/0094054 A1
(43) Pub. Date: Apr. 26, 2007

(54) Method for defining Qualified Direct Cost

(76) Inventor: Kenton C. Crabb, Chagrin Falls, OH (US)

Correspondence Address: PEARNE & GORDON LLP, 1801 EAST 9TH STREET, SUITE 1200, CLEVELAND, OH, 44114-3108, US

(21) Appl. No.: 11/584,687

(22) Filed: Oct. 20, 2006

Related U.S. Application Data
(60) Provisional application No. 60/729,136, filed on Oct. 20, 2005.

(51) Int. Cl. G06Q 40/00

(52) U.S. Cl. 705/4

(57) ABSTRACT

A method for use in connection with an insurance product under which an insurer will provide death benefits to employees of an employer includes creating an irrevocable trust as a welfare benefit fund; purchasing a whole life insurance policy, the whole life insurance policy being owned by the irrevocable trust; and creating a restricted property agreement, the terms of the agreement providing that contributions will be made to the trust sufficient to cover at least a base policy premium of the whole life insurance policy for a designated period of time, wherein the base policy premium of the whole life insurance policy constitutes the qualified direct cost.

### CROSS REFERENCE TO RELATED APPLICATIONS

The present invention claims priority to U.S. patent application Ser. No. 60/729,136 titled METHOD FOR DETERMINING QUALIFIED COST and filed on Oct. 20, 2005.

### BACKGROUND OF THE INVENTION

1) Field of the Invention

The present invention relates to a method for determining Qualified Direct Cost, and more particularly, to a method for determining Qualified Direct Cost within the meaning of the Internal Revenue Code Section 419(c)(3) without creating a reserve.

2) Description of Prior Art

When Congress drafted Internal Revenue Code (IRC) 419 and 419A there was a lot of speculation on the meaning of “Qualified Direct Cost”. IRC 419(c)(3) defines Qualified Direct Cost to mean, with respect to any taxable year, the aggregate amount (including administrative expenses) which would have been allowable as a deduction to the employer with respect to the benefits provided during the taxable year if: (1) such benefits were provided directly to the employer and (2) the employer used the cash receipts and disbursements method of accounting. For instance, the Qualified Direct Cost for a trust in the taxable year of the trust equals the premiums paid by the fund that are attributable to the insurance coverage provided during the taxable year. (See Private Letter Ruling 9325050). However, this determination still leaves taxpayers confused. Some believe that only the current mortality charges are deductible, while others believe a level “term” insurance cost can be applied to any type of life insurance coverage and that would determine the current cost with no reserve. A reserve can be created under IRC 419A(c)(2), however the reserve must be non-discriminatory as defined in IRC 505(b). The business method contemplated here, defines “Qualified Direct Cost” without creating a reserve and therefore does not need to comply with IRC 505(b).

### BRIEF SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates to a method for defining qualified cost as referred to in sections 419 and 419(a) of the Internal Revenue Code (IRC). More specifically, the present invention relates to a method of applying a whole life insurance policy and using the base portion of the premium, and possible the insurance cost of paid up additions, as a current qualified direct cost. This method facilitates discrimination in selecting employees to participate.

In accordance with an aspect of the present invention, a method for use in connection with an insurance product under which an insurer will provide death benefits to employees of an employer is provided. The method includes: creating an irrevocable trust as a welfare benefit fund; purchasing a whole life insurance policy, the whole life insurance policy being owned by the irrevocable trust; and creating a restricted property agreement, the terms of the agreement providing that contributions will be made to the trust sufficient to cover at least a base policy premium of the whole life insurance policy for a designated period of time, wherein the base policy premium of the whole life insurance policy constitutes the qualified direct cost.

In accordance with another aspect of the present invention, a method for use in connection with an insurance product under which an insurer will provide death benefits to employees of an employer is provided. The method includes: creating a whole life insurance policy to provide death benefits to an employee under a single welfare benefit plan, the whole life insurance policy having a contract premium and a paid-up addition; determining the qualified direct cost based solely on the contract premium; and using a trust agreement as a mechanism through which the employer provides welfare benefits to the employee and to designated beneficiaries of the employee.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other features and advantages of the present invention will become apparent to those skilled in the art to which the present invention relates upon reading the following description with reference to the accompanying drawing.

FIG. 1 illustrates a diagram that shows how Qualified Direct Cost is determined in accordance with an aspect of the present invention.

### DESCRIPTION OF EXAMPLE EMBODIMENTS

The present invention relates to a method of determining Qualified Direct Cost. This method provides an answer and solution for taxpayers by combining a whole life insurance policy with a restricted property agreement as defined in IRC 83. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

A 419(e) life insurance plan includes an employer creating an irrevocable welfare benefit trust that qualifies under IRC 419(e), as amended, as a welfare benefit fund. The trust is created upon the employer executing a trust agreement and funding the trust with a contribution. The trust is the mechanism through which the employer provides welfare benefits to its employees and the designated beneficiaries of the employees. In this plan, the welfare benefits provided are the death benefits paid from a life insurance policy owned by the trust. As an aside, it shall be noted that the trust consists of two funds—a welfare benefit fund which represents the funds necessary to provide the death benefit coverage and a non-welfare benefit fund that represents Section 83 property.

Having established that the trust was created for the purpose of providing a welfare benefit to employees (e.g., a death benefit), the next issue concerns the deductibility of the employer contributions to the trust. To be deductible for Federal income tax purposes, the contributions must otherwise be deductible under the IRC (e.g., under Section 162); but, the deduction is limited to the amount allowed under Section 419(b). With regard to the requirement that the contributions are otherwise deductible under the IRC, Treasury Regulation 1.162-10(a) expressly provides that amounts paid for a welfare benefit plan are deductible under Section 162(a) if such amount is an ordinary and necessary expense of the trade or business. It is recognized that such expenses incurred to fund an employee death benefit plan are ordinary and necessary business expenses.

Section 419(b) provides that the deduction allowed for contributions by an employer to a welfare benefit fund is limited to an amount that is not in excess of the welfare benefit fund's “Qualified Cost” for the taxable year. Then at Section 419(c), Qualified Cost is defined to mean the sum of the “Qualified Direct Cost” for such taxable year and any addition to a “Qualified Asset Account” (for the taxable year (not applicable to the trust). Congress limited the deductibility of contributions by an employer to a welfare benefit fund to prevent employers from utilizing welfare benefit funds as repositories for advanced funding of benefits. In other words, in the absence of the limitation described in Section 419(b), employers would make large current contributions to a welfare benefit fund and take current deductions, even if the benefit provided applies to later years.

Qualified Direct Cost.

Under the plan of the present invention, the funds contributed to the welfare benefit fund are intended to qualify as Qualified Direct Cost within the meaning of IRC Section 419(c)(3). As defined in the statute (e.g., IRC Section 419(c)(3)), Qualified Direct Cost means the aggregate amount (including administrative expenses) which would have been allowable as a deduction to the employer with respect to the benefits provided during the taxable year, if: (1) the employer provided the benefit directly to the employee; and (2) the employer used a cash method of accounting. A benefit is deemed provided when the benefit would have been includible in the income of the employee (but for provisions in Chapter One, Subtitle A of the IRC which excludes the benefit from gross income). IRC Section 419(c)(3)(B). The Qualified Direct Cost, in the context of a fully insured welfare benefit fund, is the cost of the life insurance for the period in which the coverage is provided. Stated differently, the amount of the Qualified Direct Cost for a taxable year of the welfare benefit fund includes payments by the fund for the cost of that year's employee death benefit coverage (plus any administrative expenses associated therewith).

Section 419(c)(3), expressly provides in the definition of Qualified Direct Cost that administrative expenses incurred in the provision of the welfare benefits is allowed as a deduction in the current year. Therefore, to the extent a portion of the premium to be paid by the employer in the context of the plan of the present invention is for the payment of the current year life insurance protection and the administrative expenses associated therewith, then that amount of the premium is able to be deducted under Section 162 as an ordinary and necessary business expense and such amount is within the limitation described in Section 419(b) concerning the deductibility of contributions to welfare benefit plans.

It is noted that if the life insurance policy used to fund the welfare benefit involves levelized premiums, the levelized rate reasonably relates to the costs of the insurance coverage and related administrative expenses for the current year. Otherwise, this may cause a portion of the contribution to be capitalized. Where the benefits under the plan relate primarily to the well-being of employees and where the employer has relinquished sufficient control over the contribution such that the employer cannot direct the disposition of the funds prior to their use in paying benefits, no capitalization of the expenditures is required.

In the present invention, the Qualified Direct Cost will be established in an insurance contract. In the context of a whole life policy, it is assumed that the annual base premium cost represents the cost or death benefit coverage and associated administrative expenses for that year. Thus, the portion of the contribution equal to the premium base cost will equal the Qualified Direct Cost. The portion of the contribution allocable to paid-up additions will constitute the transfer of property to the employee within the meaning of IRC Sections 402 and 83.

Tax Consequences to Corporation and Employee.

The corporation's contribution to the trust will consist of two components: a Qualified Direct Cost and the transfer of Section 83 property. It is assumed that the portion of the contribution attributable to the annual base premium cost will be the Qualified Direct Cost and the portion of the contribution attributable to the paid-up additions will be Section 83 property.

At the corporate level, the corporation will deduct the Qualified Direct Cost portion under IRC Section 162 and 419. The Section 83 property portion will be deducted by the corporation pursuant to IRC Section 162 and 83(h), assuming the employee makes an effective Section 83(b) election (as discussed below).

At the employee level, the Section 83 property contribution will generally not be taxable to the employee since the employee's rights to the funds will not be substantially vested (e.g., right to benefit is subject to condition of providing substantial future services). However, it is contemplated that the employee will make a Section 83(b) election each year with respect to the transfer of the Section 83 property, thereby reporting it as current taxable income. Any future appreciation in value attributable to the Section 83 property will not be includible in the employee's income in the future. Further, since the employee is reporting the Section 83 property in current income under IRC Section 83(b), the corporation is entitled to a tax deduction under IRC Section 83(h).

With regard to the portion of the contribution relating to the cost of the current life insurance protection and administrative expenses, this contribution by the employer is subject to the split-dollar regulations under Treasury Regulation Section 1.61-22. Pursuant to Treasury Regulation Section 1.61-22(b)(2)(i),(ii), an arrangement is treated as a split-dollar life insurance arrangement if:
a The arrangement is entered into in connection with the performance of services;
b The employer or service recipient pays directly or indirectly all or any portion of the premium; and
c either, (i) the beneficiary of all or any portion of the death benefit is designated by the employee or (ii) the employee has any interest in the cash value of the policy.

The plan of the present invention satisfies each of these requirements, such that the employer's contributions to the trust are subject to the split-dollar regulations. Therefore, the employee includes in gross income the value of the economic benefit provided by the plan. Pursuant to Treasury Regulation 1.61-22(d) the employee takes into account the full value of all economic benefits described in paragraph (d)(2) of this Section, reduced by the consideration paid directly or indirectly by the employee for those economic benefits. As described in Treasury Regulation Section 1.61-22(d)(2), the value of the economic benefits provided to the employee equals:
a The cost of current life insurance protection provided to the employee;
b The amount of the policy cash value to which the employee has current access (to the extent such amount was not actually taken into account for a prior taxable year); and
c Any economic benefits not described in (a) or (b), above, that are provided to the employee under the arrangement.

With regard to the cost of the current life insurance protection provided to the employee, the employee includes the Table 2001 Rate in gross income.

Upon termination of the trust or lapse of the substantial forfeiture restrictions, the policy will be distributed to the employee in-kind. The employee will include in taxable income the cash value of the policy less the Section 83 property as to which there is an 83(b) election and less the earnings traceable to the Section 83 property.

### EXAMPLE

The general structure of the plan is that of a single employer welfare benefit plan. The employer will create an irrevocable trust that qualifies under Section 419(e) as a “Welfare Benefit Fund.” An independent third party serves as the trustee of the irrevocable trust. The independent third party is an individual or entity that is unrelated to the employer. For instance, the independent third party can be a bank, trust company, or other separate company unrelated to the employer. The trust is a taxable trust. For Federal income tax purposes, the trust will be taxable under Subchapter J of the Tax Code. The employer makes a contribution to the trust each year for the purpose of providing death benefits to employees participating in a single employer welfare benefit plan.

The independent third party, or trustee, then uses the contributions from the employer to acquire a whole life insurance policy insuring the life of a participant in the plan. Thus, the trustee is the owner of the whole life insurance policy. As discussed below, the employee will have the right to designate the beneficiary of the policy. The life insurance policy will be a whole life policy.

As part of the single employer welfare benefit plan, the employer and each participating employee will execute a restricted property agreement under which the employee incurs a “substantial risk of forfeiture” (within the meaning of IRC Section 83) if the employee fails to work for the employer for an agreed upon period (e.g., number of years). Pursuant to the restricted property agreement, the employer will agree to pay the life insurance policy premium contributions to the trust. The primary purpose of the restricted property agreement is to create a substantial risk of forfeiture with respect to the “Section 83 property” transfer (as discussed below). However, in the event of the employee's death while employed, the employee's designated beneficiary will receive the death benefit. To be eligible for the plan, the employee cannot have majority control over the employer with respect to employer's ability to amend or terminate the plan.

In each year the plan is in existence, with regard to a specific employee, the employer will contribute the entire premium to the trust. This contribution will, in part, constitute the Qualified Direct Cost, or base policy premium, and, in part, constitute payment towards the cash value of the policy (e.g., paid-up additions). Failure to pay, at a minimum, the base policy premium during any year will cause the whole life insurance policy to lapse. The base policy premium represents the current cost of life insurance plus all administrative costs and expenses associated with the whole life insurance policy. The base policy premium is not supported by any additional premiums paid into the whole life insurance policy. This later portion of the contribution represents the “Section 83 property.” The employer will deduct for Federal income tax purposes the full amount of these contributions. The Qualified Direct Costs are deductible under IRC Sections 162 and 419, and the remaining premium contribution (i.e., the Section 83 Property) is deductible under IRC Section 83(h).

Assuming the employee makes a timely Section 83(b) election, the employer will report the amount contributed to the trust relating to the Section 83 property on the employee's W-2. Further, the employee will include the Table 2001 rate for the current cost of the life insurance protection in his/her gross income. As an aside, if the employee fails to make the Section 83(b) election, the Section 83 property transfer will not be currently taxable to the employee since the Section 83 property would be subject to substantial risk of forfeiture pursuant to the restricted property agreement. As a result of the Section 83(b) election, all future appreciation attributable to the Section 83 property will not be includible in income when it vests.

The amount of accumulation of the cash value of the policy is not currently included in the employee's gross income because the employee's right to the cash surrender value is subject to a substantial risk of forfeiture. To eliminate the imposition of a tax on the future appreciation attributable to the Section 83 property, the employee will make an 83(b) election, to currently include the Section 83 property in gross income. The risk of substantial forfeiture is that the employee's right to receive the policy is conditioned on performing substantial services for ten (10) years. If he fails to do so, the policy is distributed to the employee but he must reimburse the employer for the fair market value of the policy. As an aside, the policy cannot revert to the employer; in such event, a 100% excise tax would be imposed.

If the employee works for ten (10) years, the risk of forfeiture under the restricted property agreement will lapse and the trust will distribute the life insurance policy to the employee. The employee has to pay tax on the cash surrender value less the amount of the cash contribution previously included in the employee's gross income as a result of the Section 83(b) election and all appreciation related thereto. Also, if in any year of the plan, the employer contributes an amount to the trust in excess of the base policy premium, then the employee will make an election under IRC 83(b) to include such amount in gross income.

If the employee terminates employment before the agreed upon period of time (e.g., ten years) or if the plan is terminated prior to the end of that agreed upon period of time or if the employer fails to make any contribution to the trust during the term, then the trustee can distribute the life insurance policy to the employee, subject to the obligation that the employee must reimburse the employer the fair market value of the policy. Otherwise, the employee agrees that the life insurance policy owned by the trust will be forfeited to a charitable organization. To enforce the risk of forfeiture described in the restricted property agreement, the terms of the welfare benefit trust will contain provisions that if the trustee does not receive contributions from the employer in an amount sufficient to pay the base policy premium in each year, then the trustee is directed to transfer the whole life insurance policy to a charitable organization. The charitable organization is one as described in IRC section 501(c)(3). As stated above, the trust can contain provisions that if the failure to receive contributions in amounts sufficient to pay the base policy premium is on account of limited exceptions such as the disability of the employee then the risk of forfeiture will not apply and the trustee will be directed pursuant to the terms of the trust to transfer the whole life insurance policy to the employee.

If the employee dies while employed, then the employee's designated beneficiary will receive the insurance proceeds, without the imposition of any tax, or the obligation to reimburse the employer the fair market value of the policy. If no designated beneficiary exists, the trustee will pay the death benefits to the estate.

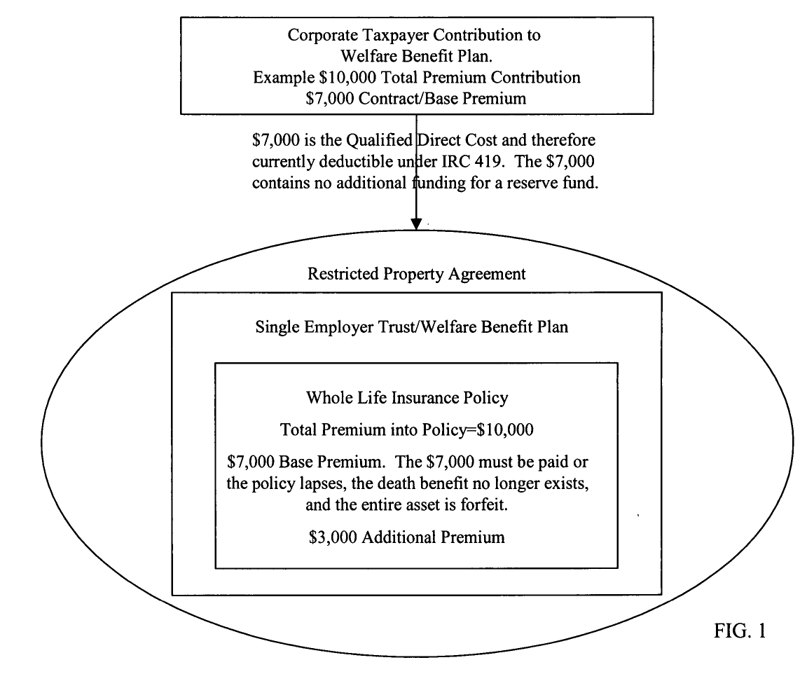

FIG. 1 illustrates a summary of how Qualified Direct Cost is determined in accordance with an aspect of the present invention. A whole life insurance policy combines a term policy with an investment component. A premium for a whole life insurance policy includes two parts. The first part is a contract or base premium, and the second part is any addition beyond the contract premium. This second part is usually referred to as a paid-up addition. In the present example, the total premium for the whole life insurance policy is $10,000. The base premium is $7,000 and the additional premium is $3,000. Some whole life insurance contracts provide that the entire contract premium, or the $7,000, must be paid in order to maintain the policy, or the policy will lapse. When an insurance policy lapses the coverage, e.g. death benefit, no longer exists. Therefore, in these types of whole life insurance contracts, the contract premium is the amount of premium attributable to the insurance coverage provided during the taxable year. The contract or base premium therefore defines the “Qualified Direct Cost”. In a Variable Universal Life insurance policy and in a Universal Life insurance policy, the premium attributable to insurance coverage is typically an adjustable renewable term premium. Therefore the Qualified Direct Cost is equal to mortality charges inside the insurance contract. Any larger current deduction creates a reserve under 419A(c)(2).

However, the owner of the whole life insurance policy, to maintain some death benefit, may change the contract and therefore the contract premium alone cannot fully define the current year's “Qualified Direct Cost”. Therefore in addition to the contract premium, a separate trust agreement is used to more clearly show that the entire contract premium is needed to maintain the existing life insurance coverage. When a restricted property agreement is used, and meets the requirements of having a substantial risk of forfeiture, within the meaning of IRC 83, this agreement requires that 100% of the contract/base premium is to be paid to the trust each year during the agreement, otherwise the life insurance policy is entirely forfeit. Therefore combining a whole life insurance policy contract premium and a restricted property agreement that meets the requirements set forth in IRC 83, in which the restricted property agreement requires 100% of the contract premium to be paid each year clearly defines a current “Qualified Direct Cost”.

The invention has been described hereinabove using specific examples; however, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A method for use in connection with an insurance product under which an insurer will provide death benefits to employees of an employer, the method comprising:
creating an irrevocable trust;
purchasing a whole life insurance policy, the whole life insurance policy being owned by the irrevocable trust; and
creating a restricted property agreement, the terms of the agreement providing that contributions will be made to the trust sufficient to cover at least a base policy premium of the whole life insurance policy for a designated period of time,
determining the qualified direct cost wherein the base policy premium of the whole life insurance policy constitutes the qualified direct cost.

2. The method of claim 1, wherein the irrevocable trust is created by an employer and is owned by a third party unrelated to the employer.

3. The method of claim 2, wherein the whole life insurance policy insures a life of an employee of the employer.

4. The method of claim 1, wherein a term of the restricted property agreement provides that contributions will be made to the trust to cover the base policy premium.

5. The method of claim 1, wherein if the base policy premium is not paid during a predetermined time period, the whole life insurance policy is forfeited to a charitable organization.

6. The method of claim 1, wherein if the base policy premium is not paid by the trust during a predetermined time period, the whole life insurance policy is transferred to the insured.

7. The method of claim 1, wherein if an amount in excess of the base policy premium is contributed to the trust during a predetermined time period, an election is made under Internal Revenue Code 83(b) by the insured to include such excess amount in the insured's gross income.

8. A method for use in connection with an insurance product under which an insurer will provide death benefits to employees of an employer, the method comprising:
creating a whole life insurance policy to provide death benefits to an employee under a single welfare benefit plan, the whole life insurance policy having a contract premium and a paid-up addition;
determining the qualified direct cost based solely on the contract premium; and
using a trust agreement as a mechanism through which the employer provides welfare benefits to the employee and to designated beneficiaries of the employee.

9. The method of claim 8, wherein the trust comprises a welfare benefit fund that represents funds necessary to provide a death benefit coverage and a non-welfare benefit fund that represents Section 83 property.

10. The method of claim 8, wherein the Qualified Direct Cost for a taxable year includes payments by a trust for the cost of that year's employee death benefit coverage plus any administrative expenses associated therewith.

11. The method of claim 8, wherein the paid-up addition constitutes transfer of property to the employee within the meaning of Internal Revenue Code Sections 402 and 83.

12. The method of claim 8, further comprising executing a restricted property agreement between the employer and the employee.
